(19) United States
(12) Patent Application Publication
(10) Pub. No.: US 2015/0170688 A1
(43) Pub. Date: Jun. 18, 2015

(54) GREASE COMPOSITION ADDITIVE FOR PIVOT BEARING ASSEMBLIES

(71) Applicant: WESTERN DIGITAL TECHNOLOGIES, INC., Irvine, CA (US)

(72) Inventor: FREDERICK J. HANKE, NEWARK, CA (US)

(73) Assignee: WESTERN DIGITAL TECHNOLOGIES, INC., Irvine, CA (US)

(21) Appl. No.: 14/231,205

(22) Filed: Mar. 31, 2014

Related U.S. Application Data
(60) Provisional application No. 61/917,774, filed on Dec. 18, 2013.

(51) Int. Cl. G11B 5/48; F16C 33/66; B23P 15/00

(52) U.S. Cl. CPC G11B 5/48; B23P 15/003; F16C 33/6633

(57) ABSTRACT

A magnetic hard disk drive compromising a head along a suspension pivoted by a pivot bearing assembly that utilizes a grease composition is provided. The grease composition comprises an additive having at least one aryl phosphite and at least one orthophosphoric acid ester. Each of the aryl phosphite and the orthophosphoric acid ester has a molecular weight of greater than about 369 g/mol., has low volatility, and has hydrolytic stability.

### CROSS-REFERENCE TO RELATED APPLICATION(S)

This application claims priority to and the benefit of U.S. Provisional Application No. 61/917,774 filed on Dec. 18, 2013, having Attorney Docket No. T6882.P and entitled, “NON-VOLATILE PIVOT GREASE ADDITIVE TO PREVENT INCREASED PIVOT TORQUE”, the entire content of which is incorporated herein by reference.

### BACKGROUND

Information storage devices are used to retrieve and/or store data in computers and other consumer electronics devices. A hard disk drive, such as a magnetic hard disk drive, is an example of an information storage device. These disk drives typically include actuator arms that suspend magnetic transducers (e.g., heads) adjacent to magnetic recording media. These actuator arms are pivoted by pivot bearing assemblies. These disk drive pivot bearing assemblies are typically lubricated by a grease composition comprising a mineral oil, a synthetic hydrocarbon oil, a thickener, and smaller molecular weight additives, such as tricresyl phosphate. Recently, disk drive demands of longer uninterrupted data streams and higher operational temperatures have led to new problems, such as increases in pivot torque due to grease deposits. These increases in pivot torque can be large enough to prevent heads from loading onto the ramp at power down. Some pivot grease compositions include an extreme pressure agent to prevent pivot bearing wear such as tricresyl phosphate. The problem with these traditional extreme pressure agents is that they are too volatile to remain within the pivot bearing assembly. Their volatile transport out of the pivot bearing assembly eliminates their protection to the pivot bearing assembly. This loss can even lead to an increase in torque-related oxidative damage within the pivot bearing assembly inner and/or outer races (discussed further below). These extreme pressure agents can also become a contamination source for the head-disk interface after they leave the pivot bearing assembly. Accordingly, there is a need for improved grease composition additives that have properties better suited for hard disk drives.

### BRIEF DESCRIPTION OF THE DRAWINGS

FIG. 1 is a top perspective view of a hard disk drive with the disk drive cover removed to enable viewing of the internal components, in accordance with one embodiment of the invention;

FIG. 2 is a top perspective view of a head stack assembly of the hard disk drive of FIG. 1 in accordance with one embodiment of the invention;

FIG. 3 is a cross-sectional view of a pivot bearing assembly of the hard disk drive of FIG. 1, in accordance with one embodiment of the invention; and

FIG. 4 is a flowchart of a process for lubricating a pivot bearing assembly, in accordance with one embodiment of the invention.

### DEFINITIONS

As used herein, the following terms and variations thereof have the meanings given below, unless a different meaning is clearly intended by the context in which such term is used.

The term “about” when used in reference to a numerical value means plus or minus ten percent of the indicated amount. For example and not by way of limitation, “about 10” means between 9 and 11, and “about 10%” means between 9% and 11%.

The term “additive” is interchangeable with “grease additive” and “agent.”

The term “alkyl” refers to an alkyl substituent or functional group as is known in the art, such as, but not limited to, an alkane missing one hydrogen such as acyclic or cycloalkyl (derived from a cycloalkane by removal of a hydrogen atom from a ring). Exemplary alkyl groups include, but are not limited to, methyl, ethyl, propyl, butyl, and the like.

The term “aryl” refers to an aryl substituent or functional group as is known in the art, such as, but not limited to, any substituent or functional group derived from an aromatic ring, i.e., phenyl, naphthyl, thienyl, and indolyl, and the like.

The term “aryl phosphite” refers to an aryl with one or more aryl substituents.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. “Consisting essentially of” and variations of the term, shall mean excluding other components or steps of essential significance. Thus, a composition consisting essentially of the recited components would not exclude trace contaminants and pharmaceutically acceptable carriers. “Consisting of” shall mean excluding more than trace elements of other components or steps. For example, a composition “consists of” a component when the composition does not contain any other components but the recited components.

The term “hydrocarbonyl” refers to a group having a carbon atom attached to the remainder of the molecule and having predominantly hydrocarbon character. The group can include, but is not limited to:

(a) hydrocarbon substituents, i.e., alkyl, aliphatic (i.e., alkyl or alkenyl), aryl, alicyclic (i.e., cycloalkyl, cycloalkenyl) substituents, aromatic substituents, aromatic-, aliphatic-, and alicyclic substituted aromatic substituents and the like, as well as cyclic substituents wherein the ring is completed through another portion of the molecule (i.e., any two indicated substituents may together form an alicyclic radical);
(b) substituted hydrocarbon substituents, that is, substituents containing non-hydrocarbon groups which, in the context of the description herein, do not alter the predominantly hydrocarbon substituent, hydroxy, alkoxy, mercapto, alkylmercapto, nitro, nitroso, and sulfoxy;
(c) hetero-substituents, that is, substituents which, while having a predominantly hydrocarbon character, in the context of this description, contain other than carbon in a ring or chain otherwise composed of carbon atoms. Hetero-atoms include sulfur, oxygen, nitrogen, and encompass substituents such as pyridyl, furyl, thienyl, and imidazolyl. In general, no more than two, preferably no more than one, non-hydrocarbon substituent will be present for every ten carbon atoms in the hydrocarbonyl group; typically, there will be no non-hydrocarbon substituents in the hydrocarbonyl group.

The term “phosphite” refers to a phosphite as is known in the art, i.e., a salt or ester of phosphorous acid.

The term “orthophosphoric acid ester” refers to an orthophosphoric acid ester as is known in the art, i.e., a phosphoric acid or an orthophosphoric acid. An “orthophosphoric acid ester” as discussed herein may be referred to as a phosphate.

The term “volatilize” means “to pass off in vapor,” or “to make volatile, to cause to pass off in vapor.”

### DETAILED DESCRIPTION

Use of small molecular weight phosphate additives, such as tricresyl phosphate, are currently being used, show improved grease wear leveling (GWL) performance in pivot bearing assemblies. These smaller molecular weight additives, however, tend to volatilize out of the pivot bearing assemblies, and can contaminate the media. The use of higher molecular weight additives described herein show improved grease wear leveling, but they also do not volatilize out of the pivot bearing assemblies. Deposit build-up in pivot bearing assemblies may cause an increase in pivot torque. Improving GWL performance in pivot bearing assemblies may decrease grease deposits and thereby prevent an increase in pivot torque. Accordingly, there is a need for grease composition additives that have lower volatility and properties better suited for hard disk drives.

The present grease additive includes low volatility, non-traditional protective agents that do not easily volatilize out of the pivot bearing assembly of disk drives, that reduce contamination at the head-disk interface (HDI) from migration of the lubricant (i.e., a grease composition), that prevent an increase in pivot torque due to fewer grease deposits, and that reduce pivot bearing assembly wear and oxidative damage (e.g., oxidative damage caused by a lubricant such as a grease composition), thereby extending the functional life of the pivot bearing assembly. The present grease additive preferably has attributes of an extreme pressure agent, is stable at high temperatures, and has hydrolytic stability.

The present grease additive preferably includes higher molecular weight phosphate/phosphite additives and/or oxidative inhibitors than those that are currently used in some disk drive assemblies. These higher molecular weight phosphate/phosphite additives are currently used in some ester oil formulations of fluid dynamic bearing motors.

The present grease additive is preferably used to lubricate a pivot bearing assembly of a hard disk drive, such as a magnetic hard disk drive. Specific components within the grease additive are chosen to optimize lubrication and wear of pivot bearing assemblies of magnetic hard disk drives. The grease additive may be added to known pivot bearing assembly grease compositions or other known grease compositions, or the additive may be included in grease compositions having thickener, mineral oil, synthetic hydrocarbon oil and the like.

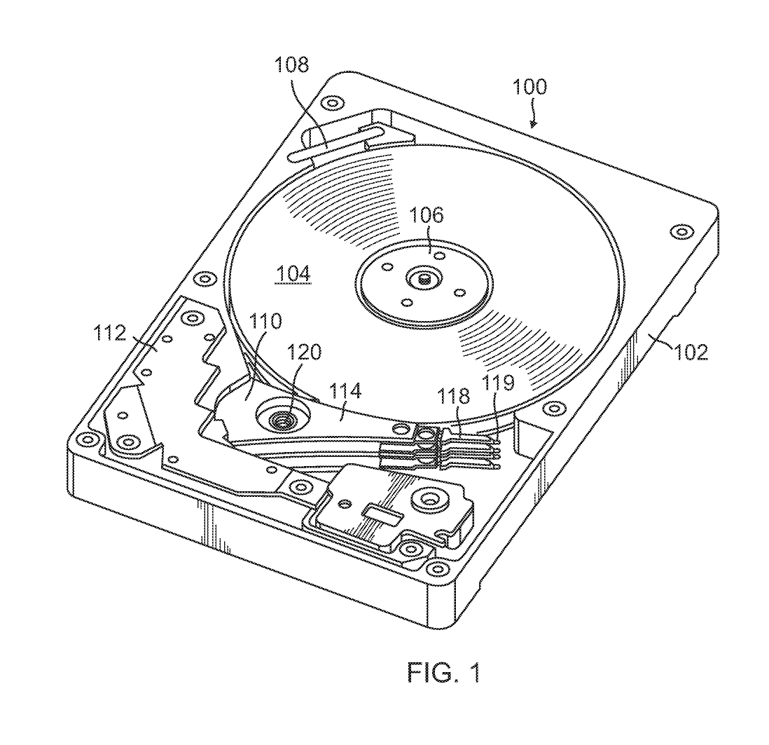

FIG. 1 is a top perspective view of an exemplary magnetic hard disk drive 100 with the disk drive cover removed to enable viewing of certain internal components. Magnetic hard disk drive 100 includes a disk drive housing 102. The present grease additive is preferably used within such a disk drive. Magnetic disk drive 100 may include a spindle 106, rotatably mounted on disk drive base 102, for rotating at least one disk 104 that is mounted on spindle 106. Magnetic hard disk drive 100 may further include a head stack assembly 110 that is pivotably mounted or suspended on disk drive base 102 by a pivot bearing assembly 120. The head stack assembly 110 may include a plurality of actuator arms 114 each supporting a head gimbal assembly (HGA) 118 with a magnetic transducer (e.g., head) 119 disposed at the end of the HGA 118. A magnet 112 may provide a magnetic field for a voice coil motor to pivot head stack assembly 110 about pivot bearing assembly 120, so that the head 119 of head gimbal assembly 118 may be desirably positioned along one or more tracks containing magnetically stored information on disk 104.

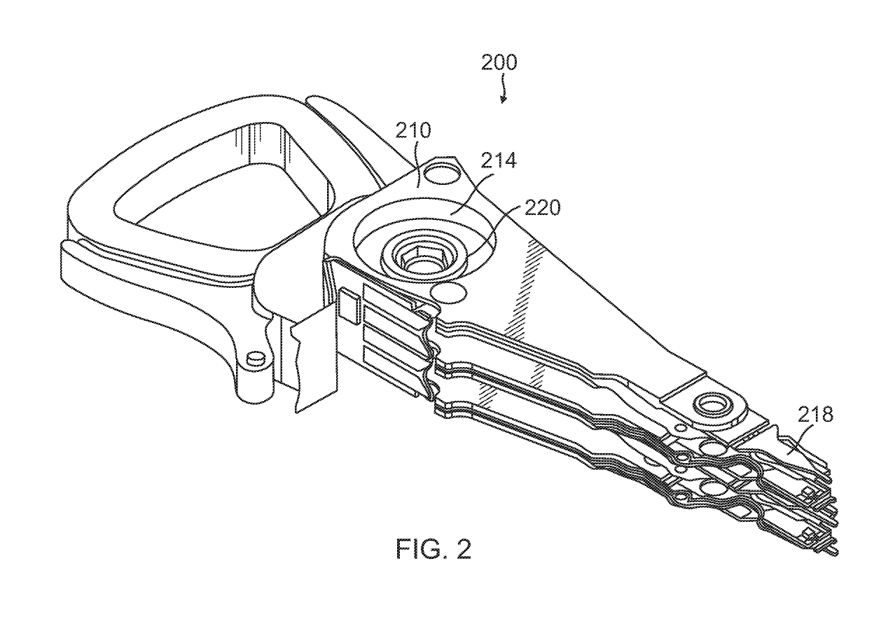

FIG. 2 is a top perspective view of an exemplary head stack assembly 200. Head stack assembly 200 may include an actuator body 210. Actuator body 210 may include a bore 214, and a pivot bearing assembly 220 (also identified as “120” in FIG. 1) disposed at least partially within bore 214. Head stack assembly 200 may also include a head gimbal assembly 118.

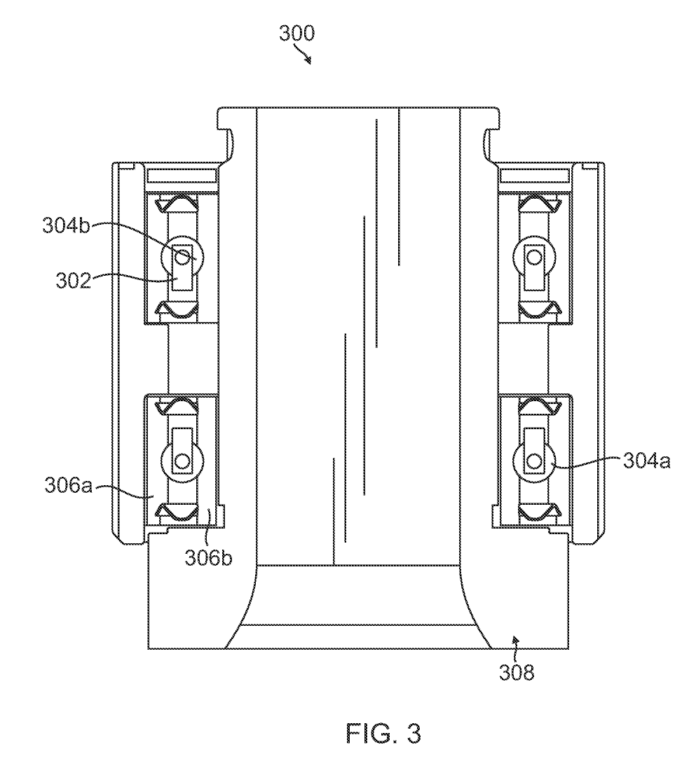

FIG. 3 is an exemplary cross-sectional view of a pivot bearing assembly 300 of magnetic hard disk drive 100 of FIG. 1. Pivot bearing assembly 300 may include an upper ball bearing 304b, a lower ball bearing 304a, an inner race 306b, an outer race 306a, a bearing cage 302, and/or an inner shaft 308. Bearing cage 302 is preferably disposed on each of lower ball bearing 304a and upper ball bearing 304b. Pivot bearing assembly 300 may be held within bore 214 (bore shown in FIG. 2) a number of different ways. For example, inner shaft 308 may be fixed to disk drive housing 102 (disk drive housing shown in FIG. 1), and a rotatable outer portion may be attached to the actuator body 210 (actuator body shown in FIG. 2). Alternatively, pivot bearing assembly 300 may be held within bore 214 of actuator body 210 by a conventional C-clip. In other embodiments, pivot bearing assembly 300 may instead have rotatable outer bearing races that are directly bonded to an inner surface of bore 214 in actuator body 210, by, for example, conventional adhesives. Exemplary disk drive pivot bearing assemblies are disclosed in U.S. Pat. No. 8,547,664 and U.S. Pat. No. 8,553,366, the contents of each of which are herein incorporated by reference in their entireties. It is to be understood that the present invention may be used within any hard disk drive pivot bearing assembly, and the pivot bearing assembly discussed herein is exemplary.

Preferably, the present grease additive comprises, consists essentially of, or consists of, at least one phosphite and/or at least one orthophosphoric acid ester. In some embodiments, the present grease additive comprises, consists essentially of, or consists of, both a phosphite and an orthophosphoric acid ester. It is to be understood that the grease additive may include at least one phosphite and/or orthophosphoric acid ester, as well as additional components. Additionally, the grease additive may include more than one phosphite and/or more than one orthophosphoric acid ester. Preferably, the grease composition, the grease additive, and/or the phosphite and/or the orthophosphoric acid ester within the grease additive, has a low volatility. Preferably, the grease additive, and/or the phosphite and/or phosphate within the grease additive, may have a volatility less than that of tricresyl phosphate and/or less than that of tricresyl phosphite, compounds typically used in pivot bearing assemblies. For example, the vapor pressure of the additive, phosphite and/or orthophosphoric acid ester within the additive may be less than about 1×10⁻⁴ mmHg at 20° C. (an exemplary vapor pressure of tricresyl phosphate—it is to be understood that the vapor pressure of tricresyl phosphate may be different). Additives and/or compounds having a vapor pressure less than about 1×10⁻⁴ mmHg 20° C., and/or less than that of tricresyl phosphate (or tricresyl phosphite), are less likely to volatilize out of the pivot bearing assembly and contaminate the media. In other embodiments, the grease composition, grease additive, phosphite, and/or orthophosphoric acid ester has a vapor pressure lower than about −9.8E-4 Torr to 7.2E-5 Torr at 75° C., or lower than the vapor pressure of tricresyl phosphate.

Preferably, the grease composition, the grease additive, the phosphite, and/or the orthophosphoric acid ester within the grease additive, has hydrolytic, thermal, and oxidative stability. Preferably, the hydrolytic, thermal, and oxidative stabilities of the grease composition, the grease additive, the phosphite and/or the orthophosphoric acid ester, are better than those of tricresyl phosphate. For example, aryl phosphites and/or orthophosphoric acid esters having butyl pendant groups (i.e., tert-butyl diphenyl phosphite) have better oxidative stability than tricresyl phosphate. Additionally, compounds having higher molecular weight alkyl chains, and having branched chains, such as aryl phosphites and/or orthophosphoric acid esters having butyl pendant groups (i.e., tert-butyl diphenyl phosphite), are hydrolytically more stable than tricresyl phosphate. Further, aryl phosphites and/or orthophosphoric acid esters having butyl pendant groups (or pendant groups heavier than methyl) have better thermal stability than tricresyl phosphate.

To accomplish the desired low volatility and hydrolytic and thermal stability, the phosphite and/or the orthophosphoric acid ester may be chosen such that it has a molecular weight greater than that of tricresyl phosphate, tricresyl phosphite, i.e., greater than about 369 g/mol. Unexpectedly, structures having a desired steric hindrance and certain molecular weights provide the optimal low volatility and hydrolytic and thermal stability specifically needed for pivot bearing assemblies of magnetic hard disk drives. Highly desired steric hindrance can be achieved with structures having three aryl groups having isopropyl/tert-butyl substituents on each, as discussed further below. The optimal steric hindrance may block access to the phosphate group. For example, phosphites and orthophosphoric esters having both alkyl and aryl groups are preferred over those having just alkyl groups. Additionally, those alkyl and aryls having alkyl groups within a certain weight range (i.e., alkyl groups heavier than the weight of a single methyl group, but less than the weight of five methyl groups, provide the optimal steric hindrance for hydrolytic stability).

The grease additive may comprise, consist essentially of, or consist of, at least one phosphite represented by Formula A:

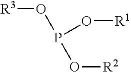

and/or
at least one orthophosphoric acid ester represented by Formula B:

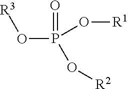

and/or a
at least one functionally equivalent phosphite and/or orthophosphoric acid ester having a molecular weight of greater than about 369 g/mol., having low volatility, and having hydrolytic stability.
wherein R¹, R², and R³ in each of Formula A and Formula B may be independently selected to be one of the following: an alkyl group; an aryl group; a hydrogen atom; a hydrocarbonyl group, and/or an OH group.

The present grease additive may comprise mixtures, combinations, derivatives, and/or decomposition products of Formulas A and/or B, or functionally equivalent phosphite and/or orthophosphoric acid esters thereof.

Preferably, Formula A is not a compound selected from the group consisting of: trioctyl phosphite, triphenyl phosphite, tricresyl phosphite, bis-2-ethylhexyl phosphite, tridecyl phosphite, dibutyl hydrogen phosphite, tris(nonylphenyl) phosphite, dilauryl hydrogen phosphite, diphenyl monodecyl phosphite, and diphenyl hydrogen phosphite; and/or Formula B is not a compound selected from the group consisting of triphenyl phosphate, triethyl phosphate, tributyl phosphate, tris(2-ethylhexyl) phosphate, tris(2-ethylhexylyl) phosphate, tridecyl phosphate, diphenyl mono(2-ethylhexylyl) phosphate, tricresyl phosphate, trioctyl phosphate, and tristearyl phosphate. The foregoing compounds are not preferred due to the lack of desired steric hindrance and optimal thermal stability.

Compounds such as trioctyl phosphite, tridecyl phosphite, tris(nonylphenyl) phosphite, dilauryl hydrogen phosphite, diphenyl monodecyl phosphite, tris(2-ethylhexyl) phosphate, tris(2-ethylhexylyl) phosphate, trioctyl phosphate, tristearyl phosphate are not preferred due to the lack of desired steric hindrance and optimal thermal stability.

Compounds such as triphenyl phosphite, tricresyl phosphite, bis-2-ethylhexyl phosphite, dibutyl hydrogen phosphite, diphenyl hydrogen phosphite, triphenyl phosphate, triethyl phosphate, tributyl phosphate, tridecyl phosphate, diphenyl mono(2-ethylhexylyl) phosphate, and tricresyl phosphate each have a molecular weight less than about 369 g/mol., and thus do not exhibit the properties (such as low volatility) desired for the grease additive of the present invention.

The grease additive may comprise, consist essentially of, or consist of,

(a) at least one aryl phosphite represented by Formula C:

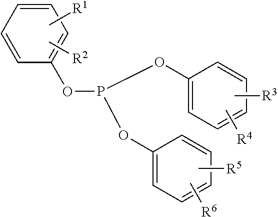

and/or
(b) at least one orthophosphoric acid ester represented by Formula D:

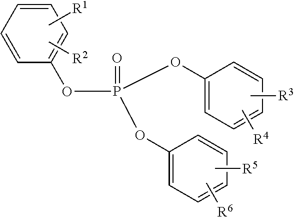

and/or
(c) at least one functionally equivalent aryl phosphite and/or orthophosphoric acid ester having a molecular weight of greater than about 369 g/mol., having low volatility, and having hydrolytic stability.

Preferably, the positions of R¹, R², R³, R⁴, R⁵, and R⁶ in each of Formula C and Formula D are not indicated, and R¹, R², R³, R⁴, R⁵, and R⁶ in each of Formula C or D may be independently selected to be one of the following: an alkyl group; an aryl group; a hydrogen atom; an OH group; and/or a hydrocarbonyl group.

Additionally, the grease additive may include mixtures, combinations, derivatives, and/or decomposition products of the foregoing (Formulas C, D, and/or functional equivalents of compounds represented by Formulas C or D having the desired properties); with the proviso that at least one of R¹, R², R³, R⁴, R⁵, and R⁶ is an alkyl group, an aryl group, or an OH group, and that the aryl phosphite is not a tris(nonylphenyl) phosphite or a tricresyl phosphite; and/or the orthophosphoric acid ester is not a tricresyl phosphate. The tricresyl phosphites/phosphates do not have the desired molecular weights or volatility, and the tris(nonylphenyl) phosphite does not have the desired steric hindrance to provide hydrolytic and thermal stability.

Preferred compounds include those wherein each of R¹, R³, and R⁵ in each of Formula C and Formula D is an alkyl group having one to ten carbon atoms; more preferably, wherein each of R¹, R³, and R⁵ in each of Formula C and Formula D is an alkyl group having one to four carbon atoms. In some embodiments, each of R¹, R³, and R⁵ in each of Formula C and Formula D is an alkyl group having at least two carbon atoms. The inventor has surprisingly found that compounds in each of Formula C and Formula D having a certain degree of steric hindrance (provided by a desired number of aryl alkyl groups) that would provide the optimal hydrolytic and thermal stability for pivot bearing assemblies of magnetic hard disk drives. Having an alkyl group having one carbon atom in each of R¹, R³, and R⁵ (i.e., tricresyl phosphate/tricresyl phosphite) in each of Formula C and Formula D increases volatility and decreases hydrolytic stability.

Exemplary compounds include those wherein the grease additive comprises the aryl phosphite represented by Formula C, wherein R¹, R³, and R⁵═C(CH₃)₃ and R², R⁴, and R⁶═H; and the orthophosphoric acid ester represented by Formula D, wherein R¹, R³, and R⁵═C(CH₃)₃ and R², R⁴, and R⁶═H (i.e., compounds having mono-substituted tert-butyl groups on each ring in any mix of ortho, meta, and para positions); the aryl phosphite represented by Formula C, wherein R¹, R³, and R⁵═CH(CH₃)₂ and R², R⁴, and R⁶═CH(CH₃)₂ or H, and the orthophosphoric acid ester represented by Formula D, wherein R¹, R³, and R⁵═CH(CH₃)₂ and R², R⁴, and R⁶═CH(CH₃)₂ or H (i.e., compounds having mono- or di-substituted isopropyl groups in any mix of ortho, meta, and para positions).

Other exemplary compounds include the aryl phosphite represented by Formula C, wherein R¹═C(CH₃)₃, and R², R³, R⁴, R⁵, and R⁶═H and/or wherein R¹, R², R³, R⁴, R⁵, and R⁶═C(CH₃)₃ (i.e., tert-butyl diphenyl phosphite and tris(2,4-di-tert-butyl-phenyl)phosphite); and/or mixtures thereof, combinations thereof, derivatives thereof, and/or decomposition products thereof; and the orthophosphoric acid ester represented by Formula D, wherein R¹═C(CH₃)₃, and R², R³, R⁴, R⁵, and R⁶═H and/or wherein R¹, R², R³, R⁴, R⁵, and R⁶═C(CH₃)₃ (i.e., tert-butylphenyl diphenyl phosphate and tris(2,4-di-tert-butyl-phenyl)phosphate; and/or mixtures thereof, combinations thereof, derivatives thereof, and/or decomposition products thereof.

A preferred grease additive comprises, consists essentially of, or consists of:

(a) an aryl phosphite represented by Formula C:

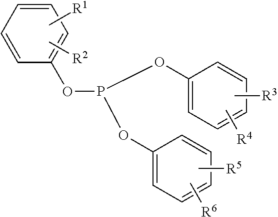

wherein each of R¹, R², R³, R⁴, R⁵, and R⁶ is C(CH₃)₃ and the positions of each of R¹, R², R³, R⁴, R⁵, and R⁶ are not indicated (thus allowing for any mix of ortho, meta, and para positions);

and

(b) an orthophosphoric acid ester represented by Formula D:

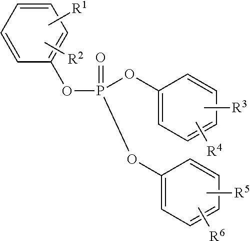

wherein each of R¹, R², R³, R⁴, R⁵, and R⁶ is C(CH₃)₃.

Another exemplary grease additive comprises, consists essentially of, or consists of an aryl phosphite; and an orthophosphoric acid ester; wherein each of the aryl phosphite and the orthophosphoric acid ester has a molecular weight of greater than about 369 g/mol., low volatility, and hydrolytic stability.

In some embodiments, the grease additive comprises the aryl phosphite represented by Formula C, and the orthophosphoric acid ester represented by Formula D, wherein a percent by weight of the aryl phosphite represented by Formula C (which can include a single aryl phosphite or a mixture of different aryl phosphites) is approximately equal to a percent by weight of the orthophosphoric acid ester represented by Formula D (which can include a single orthophosphoric acid ester or a mixture of different orthophosphoric acid esters), in the grease additive or grease composition. As such, the aryl phosphite and the orthophosphoric acid ester are present in the grease additive or grease composition in a percentage-by-weight ratio of approximately 1:1. In other embodiments, the aryl phosphite and the orthophosphoric acid ester are present in the grease additive or grease composition in a percentage-by-weight ratio of greater than, or less than, about 1:1. Preferably, an orthophosphoric acid ester is present in the grease additive, as the orthophosphoric acid ester may act as an extreme pressure agent. This extreme pressure agent may help to prevent increase in pivot torque.

In some embodiments, the grease additive comprises, consists essentially of, or consists of, the phosphite represented by Formulas A or C and the orthophosphoric acid ester represented by Formulas B or D, wherein R¹, R², R³, R⁴, R⁵, and R⁶ of Formula C is the same as R¹, R², R³, R⁴, R⁵, and R⁶ of Formula D.

The phosphite may decompose to the orthophosphoric acid ester/phosphate (and thereby replenish the orthophosphoric acid ester in the grease composition as it is consumed). The relative amounts of the aryl phosphide and the orthophosphoric acid ester may be chosen based upon the foregoing.

The grease additive may be part of a grease composition used in pivot bearing assemblies of magnetic hard disk drives. Preferably, the grease composition comprises from about 0.1% to about 5.0% by weight of the grease additive; and more preferably, from about 0.5% to about 2.0% by weight of the grease additive. In other embodiments, the grease composition may comprise more than about 5.0%, or less than about 0.1% of the inventive grease additive.

The amount of grease additive included in the grease composition may be dictated by the desired volatility, hydrolytic and/or thermal stability, for example, of the grease additive or grease composition.

Compounds represented by Formula A, Formula B, Formula C, and/or Formula D (or the present grease additive itself) may form part of an additive package in conjunction with one or more additional components such as aryl amines, conventional antioxidants, mineral oil, synthetic hydrocarbon oils, thickeners, corrosion inhibitors, anti-wear agents, and/or surface deactivators, and the like. The grease additive may serve as an extreme pressure agent in the grease composition. The relative proportions of the individual constituents are selected so that the contents are preferably mutually miscible. Exemplary additional components are described in U.S. Pat. No. 5,236,610, the contents of which are herein incorporated by reference in its entirety.

Exemplary aryl amines include, butyl diphenyl amine, naphthyl phenyl octyl amine, di-2-ethylhexylamine, bis(octylphenyl) amine, butyl diphenyl amine, and butyl octyl diphenyl amine, phenyl naphthylamine, diphenylamine, phenyl-α-naphthylamine, and p,p-dioctyldiphenylamine, amine derivatives such as aryl diphenyl amines, decomposition products thereof, combinations thereof, derivatives thereof, and/or mixtures thereof. Some of the foregoing may act as corrosion inhibitors and/or antioxidants. An exemplary mixture that may be used in the grease composition is commercially available as Vanlube 9317. The aryl amine amines may be present in an amount up to about 2 percent by weight of the grease composition. In other embodiments, the aryl amines may be present in an amount greater than about 2 percent by weight of the grease composition.

Conventional antioxidants, such as, but not limited to, sulfur-containing antioxidants such as methylene bis(dibutyldithiocarbamate), 2,6-dialkyl-p-cresol, and the like, in an amount preferably up to about 2 percent by weight of the weight of the grease composition may be used. In other embodiments, conventional antioxidants in an amount over 2 percent by weight of the grease composition may be used.

The synthetic hydrocarbon oil may be polyalphaolefin and/or an alkylated naphthalene. The polyalphaolefin is produced by the polymerization or reaction of alphaolefins with other synthetic or natural molecules as is known in the art. The hydrocarbon oil preferably contributes to the solubilization of the Formula A, Formula B, Formula C, and/or Formula D additive combination. The synthetic hydrocarbon oil may comprise from about 25 to about 65 percent by weight of the grease composition. In other embodiments, the synthetic hydrocarbon oil may comprise less than about 25 percent, or greater than about 65 percent by weight, of the grease composition.

The mineral oil may include, but is not limited to, one or more of the following: naphthenic mineral oil, paraffin mineral oil, hydrogenated mineral oil, solvent-purified mineral oil, and/or highly purified mineral oil. The amount of mineral oil present may depend on the amount of synthetic hydrocarbon oil present in the grease composition.

The synthetic hydrocarbon oil and the mineral oil of the grease composition may form a base oil. The preferred viscosity of the base oil is a dynamic viscosity of about 40 to about 80 mm²/s. An exemplary mass ratio range of mineral oil to synthetic hydrocarbon oil in the base oil is 1 to 0.05 to 2.

The thickener used in the grease composition may be a urea compound, such as a diurea compound. The thickener is added to adjust the consistency of the grease composition, and may vary in amount depending on the desired consistency. In some embodiments, the percentage by weight of thickener in the grease composition may range from about 5% to about 25%. In other embodiments, the percent by weight of thickener used in the grease composition is less than about 5% or greater than about 25%.

The grease composition of the present invention may be produced as is known in the art, and as is described in U.S. Pat. No. 5,236,610, the contents of which are herein incorporated by reference in its entirety. For example, the combination of Formula A, Formula B, Formula C, and/or Formula D may be mixed with the synthetic hydrocarbon oil, the mineral oil, and/or base oil. Subsequently, the Formula A/Formula B/Formula C/Formula D/base oil combination may be mixed with thickener and other components.

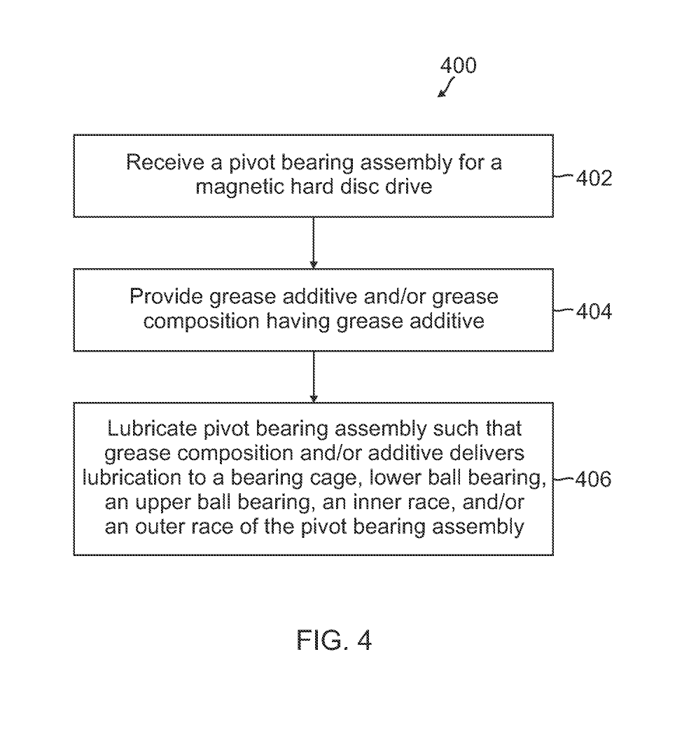

FIG. 4 is a flowchart illustrating a method 400 for lubricating a pivot bearing assembly, in accordance with one embodiment of the invention. In block 402, a pivot bearing assembly, such as, but not limited to, pivot bearing assembly 300 (depicted in FIG. 3) is received. Pivot bearing assembly 300 may include an upper ball bearing 304b, a lower ball bearing 304a, an inner race 306b, an outer race 106a, a bearing cage 302, and/or a shaft 308. Bearing cage 302 may be preferably disposed on each of lower ball bearing 304a and upper ball bearing 304b. In block 404, a grease additive and/or grease composition as disclosed herein is provided. The grease additive may be disposed on or within the bearing cage 302 and/or other pivot bearing assembly component. In block 406, the grease additive may creep into race way and may deliver lubrication to lower ball bearing 304a, upper ball bearing 304b, inner race 306b, outer race 306a, and/or bearing cage 302 while keeping the thickener within the grease composition that has poor lubricating properties out of inner race 306b and/or outer race 306a.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

The various features and processes described above may be used independently of one another, or may be combined in various ways. All possible combinations and sub-combinations are intended to fall within the scope of this disclosure. In addition, certain methods, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

What is claimed is:

1. A magnetic hard disk drive comprising a head along a suspension pivoted by a pivot bearing assembly, wherein the pivot bearing assembly utilizes a grease composition comprising an additive comprising:
a. at least one phosphite represented by Formula A: 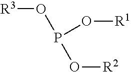
and/or
b. at least one orthophosphoric acid ester represented by Formula B: 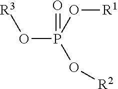
wherein R¹, R², and R³ in each of Formula A and Formula B may be independently selected to be one of the following: an alkyl group; an aryl group; a hydrogen atom;
and/or an OH group;
and/or mixtures thereof, combinations thereof, derivatives thereof, and/or decomposition products thereof;
with the proviso that the phosphite is not a compound selected from the group consisting of: trioctyl phosphite, triphenyl phosphite, tricresyl phosphite, bis-2-ethylhexyl phosphite, tridecyl phosphite, dibutyl hydrogen phosphite, tris(nonylphenyl) phosphite, dilauryl hydrogen phosphite, diphenyl monodecyl phosphite, and diphenyl hydrogen phosphite;
and/or the orthophosphoric acid ester is not a compound selected from the group consisting of triphenyl phosphate, triethyl phosphate, tributyl phosphate, tris(2-ethylhexyl) phosphate, tris(2-ethylhexylyl) phosphate, tridecyl phosphate, diphenyl mono(2-ethylhexylyl) phosphate, tricresyl phosphate, trioctyl phosphate, and tristearyl phosphate;
and/or
c. at least one functionally equivalent phosphite and/or orthophosphoric acid ester having a molecular weight of greater than about 369 g/mol., having low volatility, and having hydrolytic stability.

2. The magnetic hard disk drive of claim 1, wherein the additive comprises:
a. at least one aryl phosphite represented by Formula C: 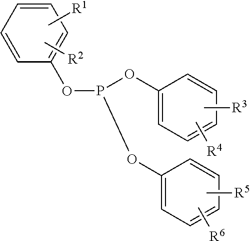
and/or
b. at least one orthophosphoric acid ester represented by Formula D: 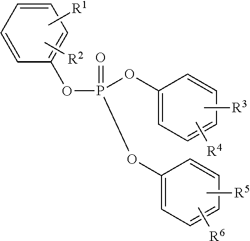
and/or
c. at least one functionally equivalent aryl phosphite and/or orthophosphoric acid ester having a molecular weight of greater than about 369 g/mol., having low volatility, and having hydroloytic stability
wherein R¹, R², R³, R⁴, R⁵, and R⁶ in each of Formula C and Formula D may be independently selected to be one of the following: an alkyl group; an aryl group; a hydrogen atom; and/or an OH group;
and/or mixtures thereof, combinations thereof, derivatives thereof, and/or decomposition products thereof;
with the proviso that at least one of R¹, R², R³, R⁴, R⁵, and R⁶ is an alkyl group, an aryl group, or an OH group, and that the aryl phosphite is not a tris(nonylphenyl) phosphite or a tricresyl phosphite; and/or the orthophosphoric acid ester is not a tricresyl phosphate.

3. The magnetic hard disk drive of claim 2, wherein each of R¹, R³, and R⁵ in each of Formula C and Formula D is an alkyl group having one to ten carbon atoms.

4. The magnetic hard disk drive of claim 3, wherein each of R¹, R³, and R⁵ in each of Formula C and Formula D is an alkyl group having one to four carbon atoms.

5. The magnetic hard disk drive of claim 2, wherein each of R¹, R³, and R⁵ in each of Formula C and Formula D is an alkyl group having at least two carbon atoms.

6. The magnetic hard disk drive of claim 4, wherein the additive comprises:
the aryl phosphite represented by Formula C, wherein R¹, R³, and R⁵═C(CH₃)₃ and R², R⁴, and R⁶═H; and
the orthophosphoric acid ester represented by Formula D, wherein R¹, R³, and R⁵═C(CH₃)₃ and R², R⁴, and R⁶═H.

7. The magnetic hard disk drive of claim 4, wherein the additive comprises:
the aryl phosphite represented by Formula C, wherein R¹, R³, and R⁵═CH(CH₃)₂ and R², R⁴, and R⁶═CH(CH₃)₂ or H; and
the orthophosphoric acid ester represented by Formula D, wherein R¹, R³, and R⁵═CH(CH₃)₂ and R², R⁴, and R⁶═CH(CH₃)₂ or H.

8. The magnetic hard disk drive of claim 2, wherein the additive comprises
the aryl phosphite represented by Formula C, wherein R¹═C(CH₃)₃, and R², R³, R⁴, R⁵, and R⁶═H and/or wherein R¹, R², R³, R⁴, R⁵, and R⁶═C(CH₃)₃; and/or mixtures thereof, combinations thereof, derivatives thereof, and/or decomposition products thereof; and
the orthophosphoric acid ester represented by Formula D, wherein R¹═C(CH₃)₃, and R², R³, R⁴, R⁵, and R⁶═H and/or wherein R¹, R², R³, R⁴, R⁵, and R⁶═C(CH₃)₃; and/or mixtures thereof, combinations thereof, derivatives thereof, and/or decomposition products thereof.

9. The magnetic hard disk drive of claim 2, wherein the grease composition comprises from about 0.1% by weight to about 5.0% by weight of the additive.

10. The magnetic hard disk drive of claim 2, wherein the additive comprises the aryl phosphite represented by Formula C, and the orthophosphoric acid ester represented by Formula D, wherein a percent by weight of the aryl phosphite represented by Formula C is approximately equal to a percent by weight of the orthophosphoric acid ester represented by Formula D, in the grease composition.

11. The magnetic hard disk drive of claim 2, wherein the additive comprises the aryl phosphite represented by Formula C and the orthophosphoric acid ester represented by Formula D, wherein R¹, R², R³, R⁴, R⁵, and R⁶ of Formula C is the same as R¹, R², R³, R⁴, R⁵, and R⁶ of Formula D.

12. A method for lubricating a pivot bearing assembly of a magnetic hard disk drive, comprising:
a. receiving the pivot bearing assembly comprising:
i. a fixed inner bearing shaft configured to attach to a magnetic hard disk drive base;
ii. at least one ball bearing, wherein each ball bearing comprises an inner race and an outer race; wherein the inner race is fixed with the fixed inner bearing shaft; and
iii. at least one bearing cap disposed on the ball bearing;
b. providing an additive on or within the bearing cap; wherein the additive comprises:
i. at least one phosphite represented by Formula A: 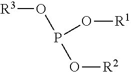
and/or
ii. at least one orthophosphoric acid ester represented by Formula B: 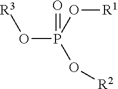
wherein R¹, R², and R³ in each of Formula A and Formula B may be independently selected to be one of the following: an alkyl group; an aryl group; a hydrogen atom;
and/or an OH group;
and/or mixtures thereof, combinations thereof, derivatives thereof, and/or decomposition products thereof;
with the proviso that the phosphite is not a compound selected from the group consisting of: trioctyl phosphite, triphenyl phosphite, tricresyl phosphite, bis-2-ethylhexyl phosphite, tridecyl phosphite, dibutyl hydrogen phosphite, tris(nonylphenyl) phosphite, dilauryl hydrogen phosphite, diphenyl monodecyl phosphite, and diphenyl hydrogen phosphite;
and/or the orthophosphoric acid ester is not a compound selected from the group consisting of triphenyl phosphate, triethyl phosphate, tributyl phosphate, tris(2-ethylhexyl) phosphate, tris(2-ethylhexylyl) phosphate, tridecyl phosphate, diphenyl mono(2-ethylhexylyl) phosphate, tricresyl phosphate, trioctyl phosphate, and tristearyl phosphate;
and/or
c. at least one functionally equivalent phosphite and/or orthophosphoric acid ester having a molecular weight of greater than about 369 g/mol., having low volatility, and having hydrolytic stability.

13. The method of claim 12, wherein the additive comprises:
a. at least one aryl phosphite represented by Formula C: 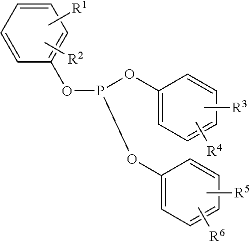
and/or
b. at least one orthophosphoric acid ester represented by Formula D: 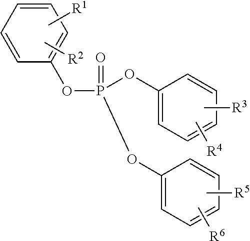
and/or
c. at least one functionally equivalent aryl phosphite and/or orthophosphoric acid ester having a molecular weight of greater than about 369 g/mol., having low volatility, and having hydrolytic stability
wherein R¹, R², R³, R⁴, R⁵, and R⁶ in each of Formula C and Formula D may be independently selected to be one of the following: an alkyl group, an aryl group, a hydrogen atom; and/or an OH group;
and/or mixtures thereof, combinations thereof, derivatives thereof, and/or decomposition products thereof;
with the proviso that at least one of R¹, R², R³, R⁴, R⁵, and R⁶ is an alkyl group, an aryl group, or an OH group, and that the aryl phosphite is not a tris(nonylphenyl) phosphite or a tricresyl phosphite; and/or the orthophosphoric acid ester is not a tricresyl phosphate.

14. The method of claim 13, wherein each of R¹, R³, and R⁵ in each of Formula C and Formula D is an alkyl group having one to four carbon atoms.

15. The method of claim 14, wherein the additive comprises:
a. the aryl phosphite represented by Formula C, wherein R¹, R³, and R⁵═C(CH₃)₃ and R², R⁴, and R⁶═H; and
b. the orthophosphoric acid ester, represented by Formula D, wherein R¹, R³, and R⁵═C(CH₃)₃ and R², R⁴, and R⁶═H.

16. The magnetic hard disk drive of claim 14, wherein the additive comprises:
a. the aryl phosphite represented by Formula C, wherein R¹, R³, and R⁵═CH(CH₃)₂ and R², R⁴, and R⁶═CH(CH₃)₂ or H; and
b. the orthophosphoric acid ester, represented by Formula D, wherein R¹, R³, and R⁵═CH(CH₃)₂ and R², R⁴, and R⁶═CH(CH₃)₂ or H.

17. The method of claim 13, wherein the grease composition comprises from about 0.1% by weight to about 5.0% by weight of the additive.

18. The method of claim 13, wherein the additive comprises the aryl phosphite represented by Formula C, and the orthophosphoric acid ester represented by Formula D, wherein a percent by weight of the aryl phosphite represented by Formula C is approximately equal to a percent by weight of the orthophosphoric acid ester represented by Formula D, in the grease composition.

19. The method of claim 13, wherein the additive comprises the aryl phosphite represented by Formula C and the orthophosphoric acid ester represented by Formula D, wherein R¹, R², R³, R⁴, R⁵, and R⁶ of Formula C are the same as R¹, R², R³, R⁴, R⁵, and R⁶ of Formula D.

20. A pivot bearing assembly comprising:
a. at least one ball bearing, wherein each ball bearing comprises an inner race and an outer race;
b. at least one bearing cap disposed on the ball bearing; and
c. a grease composition disposed on or within the bearing cap, wherein the grease composition comprises an additive comprising:
i. at least one phosphite represented by Formula A: 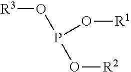
and/or
ii. at least one orthophosphoric acid ester represented by Formula B: 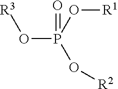
wherein R¹, R², and R³ in each of Formula A and Formula B may be independently selected to be one of the following: an alkyl group; an aryl group; a hydrogen atom;
and/or an OH group;
and/or mixtures thereof, combinations thereof, derivatives thereof, and/or decomposition products thereof;
with the proviso that the phosphite is not a compound selected from the group consisting of: trioctyl phosphite, triphenyl phosphite, tricresyl phosphite, bis-2-ethylhexyl phosphite, tridecyl phosphite, dibutyl hydrogen phosphite, tris(nonylphenyl) phosphite, dilauryl hydrogen phosphite, diphenyl monodecyl phosphite, and diphenyl hydrogen phosphite;
and/or the orthophosphoric acid ester is not a compound selected from the group consisting of triphenyl phosphate, triethyl phosphate, tributyl phosphate, tris(2-ethylhexyl) phosphate, tris(2-ethylhexylyl) phosphate, tridecyl phosphate, diphenyl mono(2-ethylhexylyl) phosphate, tricresyl phosphate, trioctyl phosphate, and tristearyl phosphate;
and/or
at least one functionally equivalent phosphite and/or orthophosphoric acid ester having a molecular weight of greater than about 369 g/mol., having low volatility, and having hydrolytic stability.

21. The pivot bearing assembly of claim 20, wherein the additive comprises:
a. at least one aryl phosphite represented by Formula C: 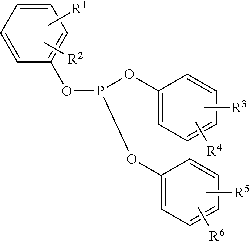
and/or
b. at least one orthophosphoric acid ester represented by Formula D: 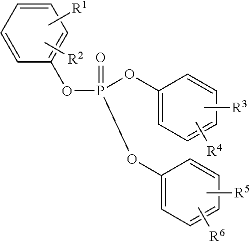
and/or
c. at least one functionally equivalent aryl phosphite and/or orthophosphoric acid ester having a molecular weight of greater than about 369 g/mol., having low volatility, and having hydrolytic stability
wherein R¹, R², R³, R⁴, R⁵, and R⁶ in each of Formula C and Formula D may be independently selected to be one of the following: an alkyl group; an aryl group; a hydrogen atom; and/or an OH group;
and/or mixtures thereof, combinations thereof, derivatives thereof, and/or decomposition products thereof;
with the proviso that at least one of R¹, R², R³, R⁴, R⁵, and R⁶ is an alkyl group, an aryl group, or an OH group, and that the aryl phosphite is not a tris(nonylphenyl) phosphite or a tricresyl phosphite; and/or the orthophosphoric acid ester is not a tricresyl phosphate.

22. The pivot bearing assembly of claim 21, wherein each of R¹, R³, and R⁵ in each of Formula C and Formula D is an alkyl group having one to four carbon atoms.

23. The pivot bearing assembly of claim 22, wherein the additive comprises:
a. the aryl phosphite represented by Formula C, wherein R¹, R³, and R⁵═C(CH₃)₃ and R², R⁴, and R⁶═H; and
b. the orthophosphoric acid ester represented by Formula D, wherein R¹, R³, and R⁵═C(CH₃)₃ and R², R⁴, and R⁶═H.

24. The pivot bearing assembly of claim 21, wherein the additive comprises the aryl phosphite represented by Formula C and the orthophosphoric acid ester represented by Formula D, wherein a percent by weight of the aryl phosphite represented by Formula C is approximately equal to a percent by weight of the orthophosphoric acid ester represented by Formula D, in the grease composition.

25. The pivot bearing assembly of claim 21, wherein the additive comprises:
a. the aryl phosphite represented by Formula C, wherein R¹, R³, and R⁵═CH(CH₃)₂ and R², R⁴, and R⁶═CH(CH₃)₂ or H; and
b. the orthophosphoric acid ester represented by Formula D, wherein R¹, R³, and R⁵═CH(CH₃)₂ and R², R⁴, and R⁶═CH(CH₃)₂ or H.

26. The pivot bearing assembly of claim 21, wherein the grease composition comprises from about 0.1% by weight to about 5.0% by weight of the additive.

27. The pivot bearing assembly of claim 21, the agent comprises the aryl phosphite represented by Formula C, and the orthophosphoric acid ester represented by Formula D, wherein R¹, R², R³, R⁴, R⁵, and R⁶ of Formula C is the same as R¹, R², R³, R⁴, R⁵, and R⁶ of Formula D.

28. A magnetic hard disk drive comprising a head along a suspension pivoted by a pivot bearing assembly, wherein the pivot bearing assembly utilizes a grease composition comprising an additive comprising:
a. an aryl phosphite; and
b. an orthophosphoric acid ester;
wherein each of the aryl phosphite and the orthophosphoric acid ester has a molecular weight of greater than about 369 g/mol., low volatility, and hydrolytic stability.

29. A magnetic hard disk drive assembly drive comprising a head along a suspension pivoted by a pivot bearing assembly, wherein the pivot bearing assembly utilizes a grease composition comprising an additive comprising:
a. an aryl phosphite represented by Formula C: 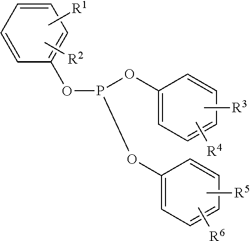
wherein each of R¹, R², R³, R⁴, R⁵, and R⁶ is C(CH₃)₃;
and
b. an orthophosphoric acid ester represented by Formula D: 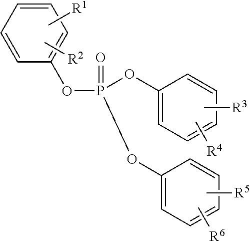
wherein each of R¹, R², R³, R⁴, R⁵, and R⁶ is C(CH₃)₃.
